(19) United States
(12) Patent Application Publication
(10) Pub. No.: US 2026/0133277 A1
(43) Pub. Date: May 14, 2026

(54) DEVICE POSITIONING

(71) Applicant: Elliptic Laboratories ASA, Oslo (NO)

(72) Inventors: Tom Øystein KAVLI, Oslo (NO); Espen KLOVNING, Strømmen (NO); Ludvik LIDICKY, Oslo (NO); Ola Sandstad, Rælingen (NO)

(73) Assignee: Elliptic Laboratories ASA, Oslo (NO)

(21) Appl. No.: 19/118,686

(22) PCT Filed: Nov. 16, 2023
(86) PCT No.: PCT/NO2023/060094

§ 371 Date: Apr. 4, 2025

(30) Foreign Application Priority Data
Nov. 18, 2022 (NO) 20221246

(51) Int. Cl. G01S 5/18

(52) U.S. Cl. CPC G01S 5/18

(57) ABSTRACT

The present invention relates to a method and related system for connecting a primary device to an external device, the primary device being configured to receive an acoustic signal within a predetermined frequency range and measure the location of the acoustic transmitter, the secondary device including an acoustic transmitter, the method including the steps of: a) the primary device detects the presence of an external secondary device; b) the primary device is requests the secondary device to transmit an acoustic signal c) the secondary device transmits a predetermined acoustic signal; d) the primary device receives the acoustic signal; e) The primary device calculating the position of the secondary device based on the received acoustic signal;

The present invention is based on calculating the relative position of one or more secondary devices to a primary device.

Connecting different types of electronic devices, e.g. for extending desktop screens, have been well known. Typically, the process is partially manual where the user is allowed through a computer interface to select and position the external screen relative to the main computer. This requires knowledge of the system and take time whenever a new setup is needed.

The present invention is aimed at simplifying the setup process for combining external devices in a system, providing a unitary experience for the user. In WO2011042748 a system is suggested where two or more screens are interacting so that the relative position between them and the relative orientation (such as distance, angle etc) is monitored using acoustic measurements. This provides the possibility to use directional gestures or pointer movements to move objects from one screen to another even in cases where the relative positions may vary.

EP3968295 describes a communication system and method for electronic devices including two or more devices and is aimed at detecting if another device is within a certain distance. The process is initiated using Bluetooth communication protocols after which for example communication through ultrasound may follow for measuring the distance. Each device includes one microphone and one speaker where both have to be active in order to find the distance, while relative orientation is seen as a problem as it makes the distance measurements less accurate.

It is an object of the present invention to provide an improved system or method for calculating and preferably monitoring the relative position as well as preferably the orientation of one or more secondary devices relative to a primary device. This is achieved as disclosed in the accompanying claims.

The present invention is thus based on communication between a primary and at least one secondary device using acoustic signals transmitted from one or more acoustic transducers in a secondary device and received and processed by one or more transceivers in a processing device of the primary device to find the relative position of the secondary device to the primary device. The processing may be done in specialized or general-purpose processors including inference engines for Deep Neural Networks (DNN). The acoustic signal is either stored in a playout buffer in the secondary device or generated on-the-fly by either the primary or secondary device. If the secondary device does not have resources including processing capability to generate the acoustic signal, the acoustic output signal can be generated by the primary device. The caveat is that the primary device must be able to transmit the acoustic signal using the acoustic transducers in the secondary device through a viable communication channel, such as a wired or wireless connection. The wired connection may go through a forwarding device that could handle more than one secondary device (e.g. wired or wireless docking station).

The primary device may initiate the process at the receipt of an acoustic or WiFi-signal, for example if the second devices has a repeating beacon or act at the request from a user to connect or when detecting an activity by the user e.g. from an inertia measuring unit (IMU) or an active use such as a computer mouse registering a pressure or “click”, but the primary device may also be activated when detecting a change in sound level or a recognized sound.

In one embodiment a computer mouse may thus provide a signal activating the distance and orientation measurement, and connection may be rejected of the distance is too large or the position is unsuitable, e. g of a right handed mouse is registered to the left of the primary device, while possibly simultaneously a second primary device may accept connection when registering the position of the mouse.

An advantage using acoustic signals for initiating a connection, distance or orientation measurement is, as discussed in WO2022189140 (P6000) that the acoustic signal is normally confined to a relatively small volume, especially in a closed room, which limits unnecessary initiations of the system. It also physically limits the transmission of signals including access information to to system, such as password information or IP-addresses and reduce noise and activity registered by other devices in the vicinity using electromagnetic communication. The acoustic signal transmitted by one or more transducers in the secondary device may be either audible or inaudible signals (e.g. ultrasound, infrasound, etc) or a mix of the two signal types. It is also possible to use one signal type first (e.g. inaudible) and use the other one afterwards (e.g. audible) in case the positioning process is difficult or inconclusive using the first signal type. If the secondary device includes more than one transducer, different acoustic signals may be sent out concurrently on the different transducers.

The present invention is further based on the concept of using recognizable audible or inaudible sounds (e.g. infrasound, ultrasound) that can be distinguished from other acoustic sources in the environment including output from any device that play out sound explicitly (e.g. radio, TV, smart speaker, hifi-system, smartphone, etc) or any object generating sound (e.g. people, pet, coffee grinder, PC fan, dishwasher, etc). This way power consumption can be limited by reducing the acoustic transmissions if there is a certain risk of connection failure.

The invention will be described more in detail below referring to the drawings, illustrating the invention by way of examples.

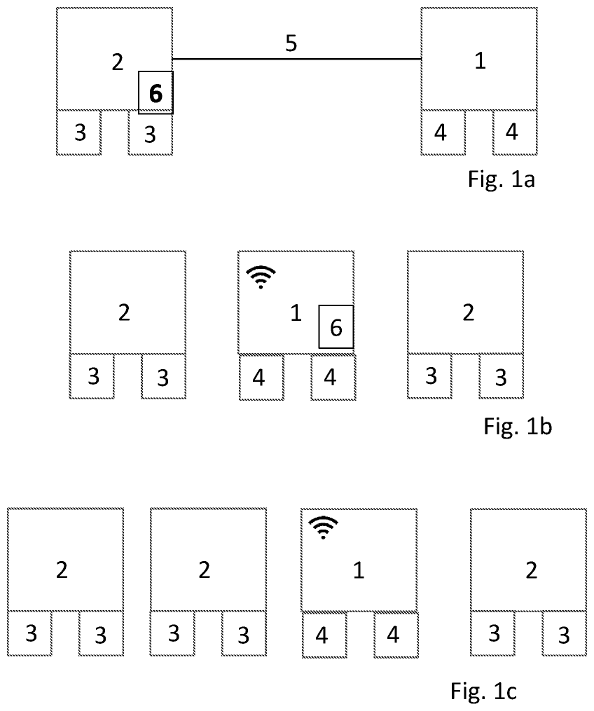

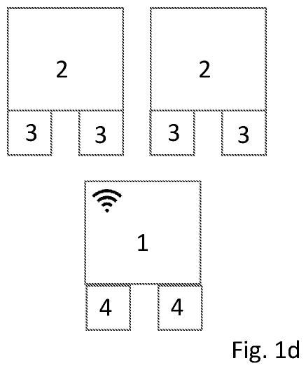

FIG. 1a-d illustrates different embodiments of the invention having a primary and at least one secondary device.

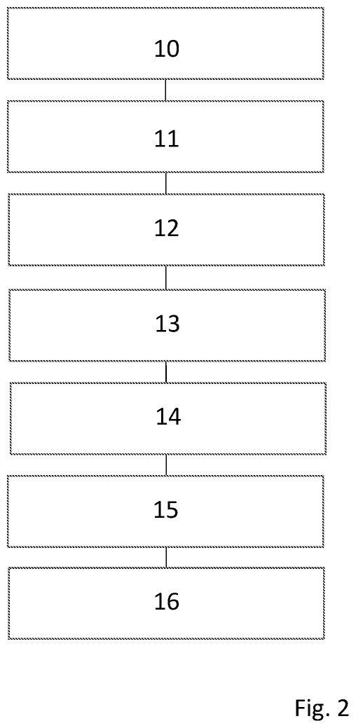

FIG. 2 illustrates the processing sequence according to the invention.

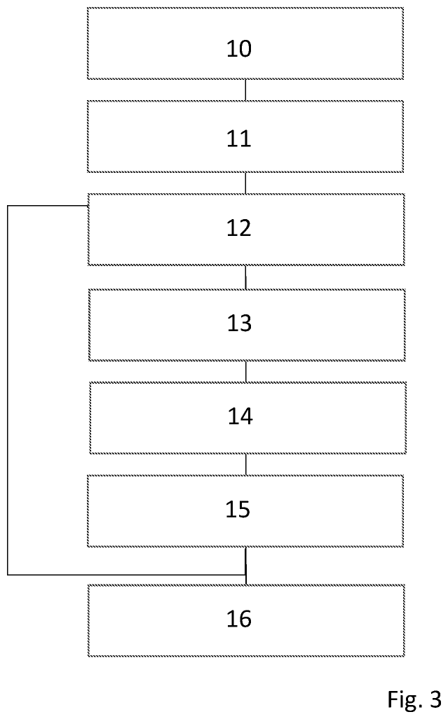

FIG. 3 illustrates an alternative sequence.

As illustrated in FIGS. 1a-1d the system according to the present invention is constituted by a primary device 1 and at least one secondary device 2 being capable of wireless or wired communication. The primary device 1 includes at least one first acoustic transducer 4 capable of receiving acoustic signals in a predetermined frequency range and the secondary device includes at least one second acoustic transducer 3 capable of transmitting signals within the predetermined frequency range.

According to the preferred embodiment of the invention the devices each has two transducers having a known distance between them. The system thus being capable of measure in a per se known way the orientation of the second device relative to the first device based on the differences in time of flight or phase for the acoustic signals from the two transmitters to the two receivers. Other solutions may, however, be possible, e.g. by transmitting a structured acoustic beam front indicating the direction of the transmitter.

In FIG. 1 a the two devices 1,2 are connected through a wired connection 5. When the connection is detected, the first device 1 is configured to send a signal to the second device instructing the second device 2 to transmit one or more acoustic signals from the transmitters 3. The signals are then received by the first device 1 through the receivers 4.

As can be seen from FIGS. 1b-1d, the first device may be capable of communicating with the second devices using WiFi or other wireless communication means. The first device will usually be waiting until a second device is detected in the vicinity and then transmit a signal instructing the second device to transmit the acoustic signal used to find the relative position between the devices. This may be repeated if another second device arrives, thus for example providing a multiscreen environment or using several sound sources, where only the new second device is asked to transmit the signal required to find the position.

The configuration in FIG. 1b may for example be constituted by a stereo system with two speakers controlled by the first device, or a laptop with two external monitors. FIGS. 1c and 1d illustrate other possible configurations.

An audible signal might not be usable if the audible noise in the environment or from concurrent audio played out on the secondary device is making the acoustic signal undetectable by the primary device. Similarly, the inaudible signal may be undetectable if interference from inaudible noise in the environment or intermodulation effects from playing concurrent audible signals on the acoustic transducers in the secondary device prevents correct positioning. Since these noise sources may not be present all the time or may possibly be periodic or random in nature, it may be possible for the primary device to transmit the acoustic signal during periods where the audible or inaudible noise sources discussed above are either manageable or non-existent. With loopback access to the concurrent audible output stream, the positioning process can predict periods in the audible signal that could be used for positioning using an audible signal. This prediction could be done using Deep Neural Network inference engines trained on audible data or prediction based on signal processing of outgoing audible signal. The amplitude of the acoustic signal may be increased to improve the SNR to make the positioning process co-exist with the other noise sources. Changing the acoustic signal to a signal with better SNR (e.g. changing signal type, frequency or frequency band, etc) is another option.

More specifically FIG. 2 illustrates the process according to the invention for connecting and positioning a secondary device.

10: The primary device detects a secondary device such as an external monitor, either by being physically connected to the device or connected using a wireless protocol.

11: When connected the positioning process is started.

12: The system, preferably the primary device, listens for noise in the environment.

13: The secondary device is instructed to transmit an acoustic signal with predetermined characteristics. If noise has been detected, the acoustic signal may be chosen to be in a different frequency range or if the noise is periodic, between the noise signals.

14: The primary device receives the acoustic signals.

15: The relative position is calculated based on the signals received at the acoustic receiver(s).

16: Once the relative position has been found, the process is stopped.

The process may be repeated if a new secondary device is detected.

FIG. 3 illustrates the process as described above in a process where the relative position between the devices may be dynamic, changing, or additional secondary devices appear or are detected. In that scenario, the system includes a step 17 reverting to step 12, listening for noise and can at a chosen rate repeat the positioning process.

As shown in FIGS. 1b-1d, there may be more than one secondary device. If so, the secondary devices will be positioned by the primary device either in parallel or one after another. The positioning order is either controlled by the primary device or by protocol request from the secondary devices using a suitable service protocol. The secondary devices or the primary device, if it is controlling the acoustic output signal, may transmit device-specific acoustic signals if the positioning is done in parallel to keep the devices apart in the positioning process.

In the preferred embodiment of the invention, the primary device is a laptop, for example part of a videoconferencing system, and the secondary devices are external monitors equipped with one or more speakers, The monitors are connected to the laptop using either a cable (e.g. HDMI, USB-C, etc) or a wireless technology (e.g. WiFi, Bluetooth, etc) ) or an optical communication technology but will in general not include processing capability to generate the output signal or include a stored acoustic signal in a playout buffer. Thus, the signal needs to be played out from a playout buffer or generated on the fly by the primary device and transmitted out on the acoustic transducers in the secondary device using the cabled or wireless connection between the primary and secondary devices (i.e. HDMI, USB-C, etc). In this embodiment, relevant information about the audio system on the external monitors is available in the Extended Display Identification Data (EDID) embedded in these external monitors and read by the laptop when the display is connected. The EDID information may include size of a monitor, speaker location, number of speakers, sampling rates, etc. All this information can be included as parameters in the signal processing of the positioning process or as processed input features to a positioning Deep Neural Network (DNN). In addition for example in a video conferencing system, the distances and orientations of the devices may be used to sound and video representation in the room, e.g. by adapting the system to the relative positions of the units.

Once the laptop detects that there is an external monitor with one or more speakers available connected to the laptop, the positioning process could be configured to start. The laptop may detect the external monitor when the device manager in the device detects that a new secondary device with at least one speaker is accessible from the primary device over an existing connection such as HDMI, WiFi, Bluetooth or USB-C etc. Once the primary and secondary devices are logically connected, the device manager will report availability of the speaker in the monitor. The detection process may trigger when the device boots, when the device resumes from sleep mode or the device restarts a process detecting secondary devices. The device polling or notification process could be done either in a driver or an application or a background service in the device.

Once the external monitor with speakers has been detected, the positioning process will start playing out the acoustic signal on one or more of the speakers of the external monitor. If the secondary device is not within range of the primary device and the positioning process fails, the position information will be unknown, and the default behavior of the primary device will be respected. This may happen if the primary device and the secondary device in question are located to far apart to make positioning feasible or in different rooms or spaces which severely limits at least ultrasound signals. If the acoustic signal is successfully received by the laptop transducers, the positioning process will determine the relative position of the external monitor to the laptop. Once the relative position is known (e.g. left, right, top, bottom, front, back, top-bottom, top-top, left-left left-right, etc.), the laptop can automatically or by prompting the user, optimize the setup and positioning of all available displays using platform specific APIs or a user-friendly UI to complete the display setup. This setup is normally known as display extension where all the available displays can be used by the laptop user.

In another embodiment, the laptop is connected to two or more external monitors and the positioning process will position one external monitor after the other or in parallel.

In another embodiment, the laptop is connected to soundbar or external speaker and the positioning process position them.

In another embodiment, the laptop may use the screen of other devices such as laptops, standalone computers, TVs, video conferencing boards, tablets, smartphones etc similar to normal use of any external monitor. In general, these secondary devices may include processing capability of their own that allows them to transmit the acoustic signal from its own speakers. However, controlling when the secondary device transmits the acoustic signal should preferably be left to the primary device to make sure that positioning process of all available secondary devices are done properly whether it is done in parallel or in sequence. These devices will normally not be connected via cable but will rely on a wireless connection between the primary device and the secondary devices (e.g. WiFi, Bluetooth, ultrasound, etc). The primary and secondary devices can use any type of discovery protocol to detect each other over the wireless connection. Securing the discovery protocol may be necessary to make sure only the secondary devices accessible to the user are detected. An alternative scheme for detecting useful secondary devices, is to let the secondary devices potentially controlled by the primary device, transmit an inaudible ultrasound signal to make sure that the secondary devices are both in the same space as the primary device and acoustically within range of it. The primary device will transmit commands or complete acoustic signals to the secondary device to enable them to transmit the correct acoustic signal from at least one of its acoustic transducers.

In one embodiment, the laptop will based on initial acoustic noise measurements of the acoustic signal received by at least one acoustic transducer, playout an acoustic signal adapted to the current acoustic noise in the environment of the devices to improve signal SNR.

In one embodiment, the laptop is connected to two or more externals monitor and the positioning process will position all the external monitors at the same time by playing out unique acoustic signals on all the external monitors at the same time.

In one embodiment, the positioning process is using either changes in static acoustic echos from the environment or sensor events from other sensors (e.g. hinge sensors, IR sensors, ToF sensors, IMU, camera, etc) indicating that the device in question is being moved to detect that either the primary or secondary devices are currently being moved, or subject to movement such as pressing a button or mouse. The primary device may redo the positioning process if the primary device or any of the secondary devices are seemingly being moved. The secondary device may if possible send an acoustic signal to tell the primary device that it has moved if the motion sensors are embedded within the secondary device. The secondary device may delay sending out the acoustic signal until the device is no longer moving. If so, the primary device may wait until the moving device in no longer moving and the positioning process may be restarted to make sure that the positioning information is correctly updated.

According to one embodiment one or more physical or virtual sensors (e. g IMU) may be used to detect movement of either the primary or secondary device triggering the positioning or orientation measuring process to run again. Typically, IMU sensors have low power consumption, which can be advantageous in portable devices. If the IMU sensor in the primary device indicates device movement during the positioning process, the positioning process should be aborted by the primary device. If the secondary device detects IMU sensor movement, it should, if possible send out a predefined signal that the positioning process failed due to device movement. The other criteria or conditions that must be fulfilled before the connection is set up including device state, device configuration (hinge angle, folded, unfolded, screen detached, lid closed etc), device orientation, power state, biometric security such as but not limited to face-id, speech recognition, fingerprint, etc. Gestures, that is, how either or both devices are handled (e.g. shaking, lifting, waving, etc) could be yet another condition that must be fulfilled for the connection to be initiated. In addition the positioning itself may provide a criteria for providing a full communication between the devices, e.g. by requiring that the second device is in front of a screen and/or within a chosen distance range in order to connect to it.

In one embodiment, the positioning process could be run at regular intervals to detect when at least one secondary device has moved relative to the primary device. The interval could be user configurable.

In another embodiment of the present invention, user input can be used to indicate if the user wants to use a specific external monitor or not. This can be achieved by intercepting mouse movements on the laptop and make sure that when a user moves the mouse out from the current screen to the screen on the right that the screen on the right is automatically extended to the right and turned on or dimming cancelled. This may enable the user to reduce power consumption by configuring power saving and only keeping the screens that are actively in use always turned on. The other screens can be turned off or dimmed for power saving reasons.

In another embodiment, the primary device may play audio (e.g. podcast, music, video, etc) that may be rerouted and played out on the speakers of the secondary device once the secondary device is connected to the primary device. In this case, the output signal from the positioning process should be mixed with the current audio output and played out on the same speakers concurrently. The output signal may be an ultrasound signal or an audible signal that can be distinguished from the audio itself.

In another embodiment, the primary device may play audio (e.g. podcast, music, video, etc) that may be rerouted and played out on the speakers of the secondary device once the secondary device is connected to the primary device. If the output signal from the positioning process cannot be mixed with the audio output and transmitted from the speakers on the secondary device, the positioning process may use the audio output for it positioning process. This may require the positioning process to either get access to the audio output to or to have a-priori information about the audio itself to simplify the positioning process. If the positioning process does not have access to the audio signal being sent out, the positioning process may have an increased failure rate.

The present invention may use existing speaker and microphones on the devices, such as one speaker on one device and two spatially separated microphones on the other device, the time of flight from the speaker to the different microphones providing a measure of the relative orientation. The opposite may also be possible where two speakers on one device may transmit a known signal and the signals received by the microphone may be analyzed based on the known signal, e.g. by finding the phase difference between the received signals.

The process may be initiated manually by the user or by detected activity at one of the devices, such as a movement which might indicate that the distance or orientation may be changed, or by detecting a change in the background sound level which may be recognized as a person entering the room or a voice command. This may lead to a transmission of a wake-up signal, preferably acoustic, from one of the devices.

To summarize the present invention relates to a communication system for electronic devices including a primary device and at least one secondary device. The devices include communication means configured to communicate with each other using a known communication protocol, such as a wired or wireless connection. The primary device is configured to detect the presence of a secondary device in the communication system according to the corresponding protocols. The secondary device is also configured to transmit at least one acoustic signal within a frequency range, the primary device being configured to receive acoustic signals within said frequency range, wherein the primary device is configured to measure the location of the secondary device based on the received signals including the direction and/or distance to the secondary device.

The primary device preferably initiate the acoustic signal from the secondary device by transmitting a request signal, where the request signal can be an acoustic signal or transmitted through the communication means. As an alternative the secondary device may be configured to transmit the acoustic signal at a predetermined sequence until receiving a communication from the primary device, e.g. a confirmation signal acknowledging connection.

At least one of the primary and secondary devices may be configured to measure and analyse the background noise using well known methods and to transmit the acoustic signal in detected low noise periods or frequency ranges. The system may include two or more secondary devices and in such cases the acoustic transmission may be initiated individually for each of them by the primary device.

If the primary and/or secondary devices comprises two acoustic transducers separated by a known distance, the system may measure the relative position using the acoustic propagation time or phase and the distance between the transducers located on the secondary device. The devices may also include inertia sensors or measuring units for initiating the relative position or location measurements at the detection of a movement and thus possible change in the position of one of the devices. Possibly the process may be initiated when the movement is constituted by a pressure applied on one of the devices such as a click on a computer mouse or key.

The present invention also relates to a method for connecting a primary device to an external secondary device, both being provided with communication means for communicating between them, such as a cable or wireless system. The primary device is configured to receive an acoustic signal within a predetermined frequency range using an acoustic transduces and measure the location of the acoustic transmitter and the secondary device including an acoustic transmitter.

The method including the steps of:
a) the primary device detects the presence of an external secondary device through the communication means;
b) the primary device requests through the communication means the secondary device to transmit an acoustic signal with specified characteristics
c) the secondary device transmits a predetermined acoustic signal;
d) the primary device receives the acoustic signal;
e) the primary device locats the position of the secondary device based on the received acoustic signal;

The detection in step a) may be triggered by detecting an initial acoustic signal transmitted from the secondary device or through an established communication channel, e.g. wired or WiFi connection, possibly initiated by a registered human activity at the second device, such as a movement, pressing a key, touch pad or a computer mouse. Steps b) to e) may be repeated at in a predetermined sequence and/or in the occurrence of a measured movement of the secondary device.

1. A communication system for electronic devices, the communication system comprising a primary device and at least one secondary device, the primary and secondary devices being configured to communicate with each other using a known communication protocol, the primary device being configured to detect the presence of a secondary device and the secondary device being configured to transmit, at a request communicated from the primary device, at least one acoustic signal within a frequency range, the primary device being configured to receive acoustic signals within said frequency range, wherein the primary device is configured to measure the location of the secondary device based on the received signals.

2. The communication system according to claim 1, wherein the primary device is configured to initiate the acoustic signal from the secondary device.

3. The communication system according to claim 1, wherein the secondary device is configured to transmit the acoustic signal at a predetermined sequence until receiving a communication from the primary device.

4. The communication system according to claim 1, wherein at least one of the primary and secondary devices is configured to measure the background noise, the communication system being configured to transmit the acoustic signal in detected low noise periods.

5. The communication system according to claim 1, comprising at least two secondary devices, the acoustic transmission from each being initiated by the primary device.

6. The communication system according to claim 1, wherein at least one of the primary and secondary devices comprises two transducers separated by a known distance, the communication system being configured to measure the relative position using the acoustic propagation time and the distance between the transducers located on the secondary device.

7. The communication system according to claim 1, wherein one of the primary or secondary devices comprises an inertia measuring unit configured to initiate the location measurements.

8. A method for connecting a primary device to an external device, the primary device being configured to receive an acoustic signal within a predetermined frequency range and measure the location of the acoustic transmitter, the secondary device comprising an acoustic transmitter, the method comprising:
a) the primary device detecting the presence of an external secondary device;
b) the primary device requesting the secondary device to transmit an acoustic signal
c) the secondary device transmitting a predetermined acoustic signal;
d) the primary device receiving the acoustic signal; and
e) the primary device calculating the position of the secondary device based on the received acoustic signal;

9. The method according to claim 8, wherein the detection in step a) is initiated by the primary device through an established communication channel.

10. The method according to claim 8, wherein the detection in step a) is triggered by detecting an initial acoustic signal transmitted from the secondary device.

11. The method according to claim 8, comprising measuring and analysis of background acoustic noise and to transmit the signal in at least one of a time window and frequency range having low noise.

12. The method according to claim 8, wherein the steps b) to e) are repeated at in at least one of a predetermined sequence and in the occurrence of a measured movement of the secondary device.

13. The method according to claim 8, wherein the detection of a second device is initiated by a registered activity by the second device.

14. The communication system according to claim 3, wherein the communication from the primary device is a confirmation signal acknowledging connection.

15. The method according to claim 9, wherein the established communication channel is selected from the group consisting of a wired connection and a WiFi connection.
